(19) United States
(12) Patent Application Publication
(10) Pub. No.: US 2021/0362344 A1
(43) Pub. Date: Nov. 25, 2021

(54) SYSTEM AND METHOD FOR OPERATING A DIGITAL ASSISTANT BASED ON DEVIATION FROM ROUTINE BEHAVIOR OF A USER USING THE DIGITAL ASSISTANT

(71) Applicant: Intuition Robotics, Ltd., Ramat-Gan (IL)

(72) Inventors: Shay ZWEIG, Harel (IL); Alex KEAGEL, Tel Aviv (IL); Itai MENDELSOHN, Tel Aviv (IL); Roy AMIR, Mikhmoret (IL); Dor SKULER, Oranit (IL); Eldar RON, Tel Aviv (IL)

(73) Assignee: Intuition Robotics, Ltd., Ramat-Gan (IL)

(21) Appl. No.: 17/324,263

(22) Filed: May 19, 2021

Related U.S. Application Data
(60) Provisional application No. 63/027,077, filed on May 19, 2020.

(51) Int. Cl. B25J 11/00; B25J 13/08; G06N 20/00; G10L 15/22

(52) U.S. Cl. CPC B25J 11/0005; B25J 13/08; G10L 2015/223; G10L 15/22; G06N 20/00

(57) ABSTRACT

A system and method for operating a digital assistant based on deviation from routine behavior of a user using the digital assistant are provided. The method includes analyzing a first collected dataset to determine at least routine information regarding the user; analyzing a second dataset and the determined routine information regarding the user to determine a deviation level value, the deviation level value describing the deviation of a current behavior from routine behavior of the user, and wherein the second dataset includes real-time data regarding the user; determining a plan for the digital assistant, wherein the plan includes at least one action to be performed by the digital assistant; and operating the digital assistant based on the determined plan, thereby causing the digital assistant to adjust the behavior of the user.

### CROSS-REFERENCE TO RELATED APPLICATIONS

This application claims the benefit of U.S. Provisional Application No. 63/027,077 filed on May 19, 2020, the contents of which are hereby incorporated by reference.

### TECHNICAL FIELD

The disclosure generally relates to electronic systems and, more specifically, to a system and method for executing a plan by a digital assistant based on a deviation level from a routine information of a user of the digital assistant.

### BACKGROUND

As manufacturers continue to improve electronic device functionality through the inclusion of processing hardware, users, as well as manufacturers themselves, may desire expanded feature sets to enhance the utility of the included hardware. Examples of technologies which have been improved, in recent years, by the addition of faster, more-powerful processing hardware include cell phones, personal computers, vehicles, and the like. As described, such devices have also been updated to include software functionalities which provide for enhanced user experiences by leveraging device connectivity, increases in processing power, and other functional additions to such devices. However, the software solutions described, while including some features relevant to some users, may fail to provide certain features which may further enhance the quality of a user experience.

Many modern devices, such as cell phones, computers, vehicles, and the like, include software suites which leverage device hardware to provide enhanced user experiences. Examples of such software suites include cell phone virtual assistants, which may be activated by voice command to perform tasks such as playing music, starting a phone call, and the like, as well as in-vehicle virtual assistants configured to provide similar functionalities. While such software suites may provide for enhancement of certain user interactions with a device, such as by allowing a user to place a phone call using a voice command, the same suites may fail to provide routine-responsive functionalities, thereby hindering the user experience. As certain currently-available user experience software suites for electronic devices may fail to provide routine-responsive functionalities, the same suites may be unable to identify, and adapt to, a user's daily routines, thereby requiring a user to repeat certain interactions with an electronic device, where the user, in view of the user's routine, may wish to have such interactions performed automatically, which may limit user experience quality.

Further, in addition to the lack of routine-responsive features in certain currently-available user experience software suites, the same suites may also lack enhanced routine-responsive functionalities, including routine deviation detection. Routine deviation detection is an advanced routine-responsive functionality, providing for adjustment of routine-responsive features to deviations from a user's typical routine. Routine deviation detection features may provide for enhancement of an electronic device user experience, and may include certain adaptive functionalities configured to automatically improve routine-responsive features, and the software suites including such features, by detecting deviations from user routines. However, in addition to the lack of support for routine-responsive features in certain currently-available software suites, the same suites may fail to include routine deviation detection functionalities, limiting the applicability of such suites in optimization of a user's interaction with an electronic device.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for operating a digital assistant based on deviation from routine behavior of a user using the digital assistant. The method comprises: analyzing a first collected dataset to determine at least routine information regarding the user; analyzing a second dataset and the determined routine information regarding the user to determine a deviation level value, the deviation level value describing the deviation of a current behavior from routine behavior of the user, and wherein the second dataset includes real-time data regarding the user; determining a plan for the digital assistant, wherein the plan includes at least one action to be performed by the digital assistant; and operating the digital assistant based on the determined plan, thereby causing the digital assistant to adjust the behavior of the user.

Certain embodiments disclosed herein also include a non-transitory computer readable medium having stored thereon instructions for causing a processing circuitry to execute a process, the process comprising: analyzing a first collected dataset to determine at least routine information regarding the user; analyzing a second dataset and the determined routine information regarding the user to determine a deviation level value, the deviation level value describing the deviation of a current behavior from routine behavior of the user, and wherein the second dataset includes real-time data regarding the user; determining a plan for the digital assistant, wherein the plan includes at least one action to be performed by the digital assistant; and operating the digital assistant based on the determined plan, thereby causing the digital assistant to adjust the behavior of the user.

Certain embodiments disclosed herein also include a system for operating a digital assistant based on deviation from routine behavior of a user using the digital assistant. The system comprises: a processing circuitry; and a memory, the memory containing instructions that, when executed by the processing circuitry, configure the system to: analyze a first collected dataset to determine at least routine information regarding the user; analyze a second dataset and the determined routine information regarding the user to determine a deviation level value, the deviation level value describing the deviation of a current behavior from routine behavior of the user, and wherein the second dataset includes real-time data regarding the user; determine a plan for the digital assistant, wherein the plan includes at least one action to be performed by the digital assistant; and operate the digital assistant based on the determined plan, thereby causing the digital assistant to adjust the behavior of the user.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system utilized for executing a plan by a digital assistant based on a deviation level from a routine information of a user of the digital assistant, according to an embodiment.

FIG. 2 is a block diagram of a controller, according to an embodiment.

FIG. 3 is a flowchart illustrating a method for executing a plan by a digital assistant based on a deviation level from a routine information of a user of the digital assistant, according to an embodiment.

FIG. 4 is a flowchart illustrating a method for executing a plan by a digital assistant based on a detected anomaly level value that is associated with a user of the digital assistant, according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

The disclosure teaches a system and method for executing a plan by a digital assistant, connected to an input/output (I/O) device, based on a deviation level from a routine information of a user of the digital assistant. After routine information of a user is determined, real-time data is collected and analyzed with respect to the routine information. Based on the result of the analysis, a deviation level from the determined routine information of the user is determined. The deviation level is used as an input into the decision-making model of the digital assistant. Then, a plan is executed by the digital assistant based on the determined deviation level. The disclosure further teaches a system and method for executing a plan by a digital assistant based on a detected anomaly level value that is associated with a user of the digital assistant.

The systems and methods described herein provide for the identification of anomalies and deviations in user activity, and the adjustment and execution of plans based on such deviations and anomalies. The systems and methods described herein provide for increased objectivity in such processes, when compared with the execution of such processes by a human actor. As a human actor may be limited to observation of routine information, without the capacity to objectively analyze deviations and anomalies, such human observations may be subjective. As the disclosed systems and methods provide for improved objectivity in identification of behavioral anomalies and deviations, the subsequent updating of digital assistant plans, and the execution of plans based thereupon, may similarly benefit from the improved objectivity of the systems and methods disclosed herein.

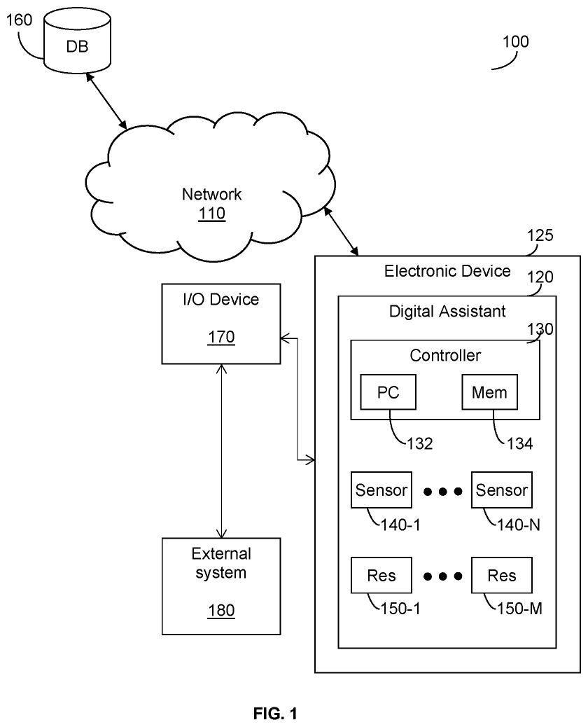

FIG. 1 is an example network diagram of a system 100 utilized to describe the various embodiments of executing a plan based on a deviation level from routine information of a user. The system 100 includes a digital assistant 120 and an electronic device 125 as well as an input/output (I/O) device 170 connected to the electronic device 125, and an external system 180 connected to the I/O device 170. In some embodiments, the digital assistant 120 is further connected to a network 110, where the network 110 is used to communicate between different parts of the system 100. The network 110 may be, but is not limited to, a local area network (LAN), a wide area network (WAN), a metro area network (MAN), the Internet, a wireless, cellular or wired network, and the like, and any combination thereof.

In an embodiment, the digital assistant 120 may be connected to, or implemented on, the electronic device 125. The electronic device 125 may be, for example, and without limitation, a robot, a social robot, a service robot, a smart TV, a smartphone, a wearable device, a vehicle, a computer, a smart appliance, or the like.

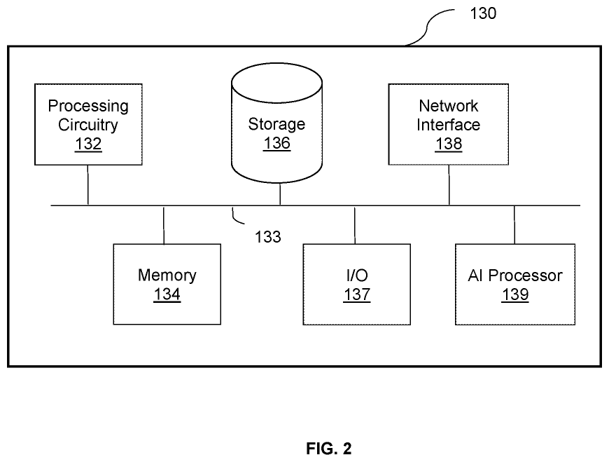

The digital assistant 120 includes a controller 130, explained in more detail below in FIG. 2, having at least a processing circuitry 132 and a memory 134. The digital assistant 120 may further include, or is connected to, one or more sensors 140-1 to 140-N, where N is an integer equal to or greater than 1 (hereinafter referred to as sensor 140 or sensors 140 merely for simplicity) and one or more resources 150-1 to 150-M, where M is an integer equal to or greater than 1 (hereinafter referred to as resource 150 or resources 150 merely for simplicity). The resources 150 may include, for example, electro-mechanical elements, display units, speakers, and so on. In an embodiment, the resources 150 may encompass sensors 140 as well.

The sensors 140 may include input devices, such as various sensors, detectors, microphones, touch sensors, movement detectors, cameras, and the like. Any of the sensors 140 may be, but are not necessarily, communicatively or otherwise connected to the controller 130 (such connection is not illustrated in FIG. 1 merely for the sake of simplicity and without limitation on the disclosed embodiments). The sensors 140 may be configured to sense signals received from one or more users, the environment of the user (or users), and the like. The sensors 140 may be positioned on or connected to the electronic device 125 (e.g., a vehicle, a robot, and so on). In an embodiment, the sensors 140 may be implemented as virtual sensors that receive inputs from online services, e.g., the weather forecast, user's electronic calendar, and so on.

In one embodiment, the system 100 further includes a database 160. The database 160 may be stored within the digital assistant 120 (e.g., within a storage device not shown), or may be separate from the digital assistant 120 and connected thereto via the network 110. The database 160 may be utilized for storing, for example, historical data about one or more users, historical routine information of the user, and the like, as further discussed hereinbelow with respect to FIG. 2.

The I/O device 170 is a device configured to generate, transmit, receive, or the like, as well as any combination thereof, one or more signals relevant to the operation of the external system 180. In an embodiment, the I/O device 170 is further configured to at least cause one or more outputs in the outside world (i.e., the world outside the computing components shown in FIG. 1) via the external system 180 based on plans determined by the assistant 120 as described herein.

The I/O device 170 may be communicatively connected to the electronic device 125 and the external system 180. It may be understood that while the I/O device 170 is depicted as separate from the electronic device 125, it may be understood that the I/O device may be included in the electronic device 125, or any component or sub-component thereof, without loss of generality or departure from the scope of the disclosure.

The external system 180 is a device, component, system, or the like, configured to provide one or more functionalities, including various interactions with external environments. The external system 180 is a system separate from the electronic device 125, although the external system 180 may be co-located with, and connected to, the electronic device 125, without loss of generality or departure from the scope of the disclosure. Examples of external systems 180 include, without limitation, air conditioning systems, lighting systems, sound systems, and the like.

FIG. 2 is an example block diagram of the controller 130, according to an embodiment. The controller 130 includes a processing circuitry 132 that is configured to receive data, analyze data, generate outputs, and the like, as further described hereinbelow. The processing circuitry 132 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 130 further includes a memory 134. The memory 134 may contain therein instructions that, when executed by the processing circuitry 132, cause the controller 130 to execute actions as further described hereinbelow. The memory 134 may further store therein information, e.g., data associated with one or more users, historical data, historical data about one or more users, historical routine information of the user, user parameters, and the like.

In an embodiment, the controller 130 includes a network interface 138 that is configured to connect to a network, e.g., the network 110 of FIG. 1. The network interface 138 may include, but is not limited to, a wired interface (e.g., an Ethernet port) or a wireless port (e.g., an 802.11 compliant Wi-Fi card) configured to connect to a network (not shown).

The storage 136 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The controller 130 further includes an input/output (I/O) interface 137 configured to control the resources 150 (shown in FIG. 1) that are connected to the digital assistant 120. In an embodiment, the I/O interface 137 is configured to receive one or more signals captured by the sensors 140 of the digital assistant 120 and to send them to the processing circuitry 132 for analysis. According to one embodiment, the I/O interface 137 is configured to analyze the signals captured by the sensors 140, detectors, and the like. According to a further embodiment, the I/O interface 137 is configured to send one or more commands to one or more of the resources 150 for executing one or more plans (e.g., actions) of the digital assistant 120, as further discussed hereinbelow. For example, a plan may include initiating a navigating plan, suggesting that the user activate an auto-pilot system of a vehicle, play Jazz music by a service robot, and the like. According to a further embodiment, the components of the controller 130 are connected via a bus 133.

In an embodiment, the controller 130 further includes an artificial intelligence (AI) processor 139. The AI processor 139 may be realized as one or more hardware logic components and circuits, including graphics processing units (GPUs), tensor processing units (TPUs), neural processing units, vision processing units (VPUs), reconfigurable field-programmable gate arrays (FPGAs), and the like. The AI processor 139 is configured to perform, for example, machine learning based on sensory inputs received from the I/O unit 137, which receives input data, such as sensory inputs, from the sensors 140. In an embodiment, the AI processor 139 may be adapted to determine routine information of the user, to determine a deviation level value from the determined at least one routine information, or the like, as further discussed hereinbelow.

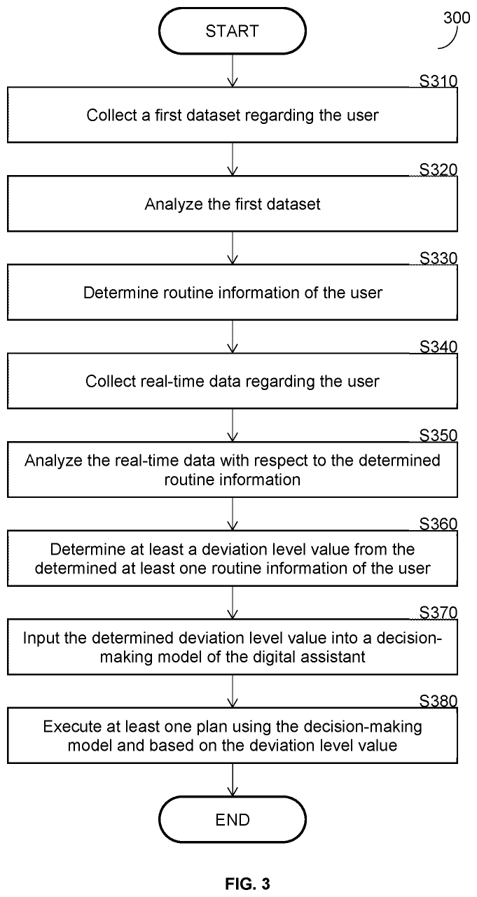

FIG. 3 is an example flowchart 300 illustrating a method for executing a plan by a digital assistant based on a deviation level from a user's routine, according to an embodiment. The method described herein may be executed by a digital assistant by means of the controller (e.g., controller 130, that is further described hereinabove with respect to FIG. 2. Alternatively or collectively, the method may be performed by the I/O device 170. A plan is an action perform by the digital assistant without an implicit input from the user.

At S310, a first dataset is collected about a user of a digital assistant. e.g., the digital assistant 120 shown in FIG. 1. The user may be located within a predetermined distance from one or more sensors of the digital assistant 120. The data may include information about the user, historical data, sensor data, environmental data, and so on. The first dataset may be collected using at least a first sensor (e.g., the sensors 140) that is communicatively connected to the digital assistant 120. The first dataset may include, for example, images, video, audio signals, historical data of the user, data from one or more web sources, data from the user's electronic calendar, and the like.

In an embodiment, the collected first dataset may be related to the environment of the user. For example, the collected first dataset may include the temperature outside the user's house or vehicle, traffic conditions, noise levels, a count of number of people located in close proximity to the user, and the like. In an embodiment, at least a portion of the first dataset may be collected using at least a first sensor (e.g., one the sensors 140) that is connected to the digital assistant. It should be noted that multiple sensors may be used for collecting the first dataset. The first dataset may be constantly or periodically collected.

At S320, the first dataset is analyzed to identify various patterns of repeated actions or behavior of the user's activity. The analysis of the first dataset may include applying at least one algorithm, such as a machine learning algorithm to the first dataset. The first dataset may include a first set of features that may be extracted from the first dataset, providing for determination of the circumstances near the user. The first set of features may refer to, for example and without limitation, a number of people in the room, a room temperature, a noise level, an action performed by the user, the way an action is performed by the user, and the like. The extracted first set of features may also refer to the weather parameters, the time of day, and the like.

The analysis of the first dataset may include the application of one or more analyses, algorithms, or the like, which may be configured to identify various patterns of repeated actions or behavior within the user's activity, where such activity may be represented by one or more data features (or parameters) included in the first dataset. Such analyses, algorithms, or the like, may be standard, pre-configured pattern-recognition models, algorithms, or the like. Further, the analysis of the first dataset may include the application of one or more thresholds, providing for identification of patterns of activity, behavior, or the like, which rise to the level of routine activity, as well as patterns which do not. Such threshold evaluation may include the analysis of the degree to which one or more user actions, behaviors, or the like, are repeated, thereby indicating, for a routine, a degree of repetitiveness associated with the actions or behaviors which are included in the routine. As an example, a threshold may be applied to identify routine activity in a detected pattern of behavior, where the detected pattern of behavior includes indications that a user wakes up at 7 AM every day, as reflected in thirty days' worth of sensor data. Further, as an additional example, a threshold may be applied to identify a behavior pattern as non-routine activity where the dataset indicates various user wake-up times ranging between 7 AM and 12 AM during a predetermined time period.

In an embodiment, the analysis of the first dataset may be achieved using, for example and without limitation, one or more computer vision techniques, audio signal processing techniques, machine learning techniques, and the like. In an embodiment, a first algorithm, such as a machine learning model, is applied to the at least a first dataset. The machine learning model may be trained to determine at least one routine information of the user based on the at least a first dataset. In a further embodiment, the first dataset is analyzed using, for example and without limitation, one or more computer vision techniques, audio signal processing techniques, machine learning techniques, and the like. For example, routine information may indicate that the user usually wakes up at 7 AM, that the user takes medications at 7:45 am, that the user usually calls to his/her children between 6-7 PM, and the like.

At S330, routine information of the user is determined based on the analysis of the first dataset. The routine information may indicate the user's patterns, habits, and the like. For example, and without limitation, routine information may indicate that the user usually participates in a yoga class every Thursday at 6 PM, that the user usually interacts with the digital assistant (e.g., the digital assistant 120) first thing in the morning, that the user takes medications every day at 4 PM, and the like.

As another example, a first dataset is collected through time and analyzed. The result of the analysis may indicate that the user usually takes his/her medications when there is no one except the user in the room. The result of the analysis may further indicate that the user usually takes his/her medications every day at 4 PM.

As another example, the routine information may indicate that the user usually gets into his/her vehicle and drives to work every weekday at 7:45 AM, that the user is stressed when traffic is heavy, that the user usually likes to listen to Jazz music when the user is alone in the vehicle, and the like. The routine information may be determined by the at least a first algorithm upon identification of certain patterns of the user, certain habits, or the like.

At S340, real-time data regarding the user is collected. The real-time data may be collected using at least a second sensor (e.g., one of the sensors 140). The real-time data may be collected with respect to the environment near the user as well as with respect to the user. The set of real-time data may be collected using at least a second sensor (e.g., one of the sensors 140) that is communicatively connected to the digital assistant (e.g., the digital assistant 120). It should be noted that the aforementioned first sensor and the second sensor may be the same sensor or the same group of sensors. That is, according to an embodiment, the same sensors may be used for collecting the first dataset and the real-time data. In a further embodiment, the real-time data is collected with respect to the environment in close proximity to the user.

At S350, the real-time data is analyzed with respect to the determined routine information. The analysis of the real-time data may be achieved by applying at least an algorithm. As an example, a machine learning model is applied on the collected set of real-time data and the determined routine information of the user. The analysis, at S350, of real time data, may return one or more outputs including, without limitation, one or more time parameters or values indicative on a routine information.

At S360, a deviation level value from the determined routine information of the user is determined based on the result of the analysis. The deviation level value may indicate the disparity between the real-time data and the determined routine information of the user. The deviation level value may be determined by application of a second algorithm to the result of the analysis executed at S350.

The second algorithm may be adapted to determine a deviation level value from the routine information of the user based on the collected real-time data, as further discussed hereinabove. The second algorithm may be configured to compare one or more parameters of the real-time data with corresponding parameters of the routine information, including a baseline parameter value, to identify one or more deviations. Further, the second algorithm may be configured to apply or otherwise implement one or more anomaly-scoring routines, methods, models, algorithms, analyses, or the like, as are known in the art, to determine a deviation level score. In an embodiment, the first set of features that is associated with the determined at least one routine information of the user and a second set of features that may be extracted from the real-time data may be compared, thereby providing for determination of the deviation level value. As further discussed herein above, a feature may be, for example and without limitation, the number of people in the room, a room temperature, a noise level, an action performed by the user, the way an action is performed by the user, and the like.

Determination of a deviation level value, at S360, may include comparison of the analyzed real-time data, as analyzed at S350, with determined routine information to identify one or more deviations, as well as deviation level values thereof. The determination of a deviation level value, by comparison, at S360, may include the application of one or more machine learning (ML) algorithms, models, or the like, where such algorithms, models, or the like, may be configured to detect anomalies or deviations in user behavior. Further, determination of a deviation level value, at S360, may include comparison of one or more results of the analysis at S350 with various threshold values, providing for identification of analysis results which exceed, or fall within, the limits defined by the threshold values.

Determination, at S360, may include comparison of one or more user states with determined routine information to identify deviations. User states are descriptions of the status, circumstances, or the like, of a user. User states may be defined in terms of one or more parameters including, as examples and without limitation, the user's level of wakefulness, the user's health condition, the user's mood, whether the user is alone, and the like. Such user states may be generated based on various data features (or parameters), collected from various sources as described herein, where such generation includes analysis of current sensor data to determine a current state. Examples of user states include “sleeping,” “cooking,” and the like. Where execution of S360 includes one or more user state comparisons, such comparisons may be executed by determining one or more user states based on the analyzed real-time data, as well as the comparison of such states with routine information. As an example, such a comparison may include the determination, based on the analyzed real-time data, that a user has been asleep for six hours, which may be determined not to be a deviation where the relevant routine information indicates that the user typically sleeps for eight hours. Where determination at S360 includes such state comparisons, user states may be determined as described in co-pending U.S. application Ser. No. 17/316,963, to the common applicant, the contents of which are hereby incorporated by reference.

As a first example, where analysis of collected real-time data indicates that a user has been sleeping for the past eight hours, and where routine information for the same user indicates that the user typically sleeps for six hours, a deviation may be identified where the deviation exceeds a predefined threshold. Further, in a second example, where analysis of collected real-time data indicates that the user has been sleeping for six-and-a-half hours, where the user's routine information indicates that the user typically sleeps for six hours, a deviation may be identified, but the identified deviation may fall within the limits defined by a predefined threshold deviation value.

In an embodiment, at least a second algorithm is applied, such as a machine learning algorithm or model, to the set of real-time data and the determined at least one routine information. The at least a second algorithm is adapted to determine, based on analysis of the real-time data, a deviation level value from the determined at least one routine information of the user. In an embodiment, the determined deviation level value may indicate the difference between the real-time data and the determined routine information of the user.

For example, by applying the second algorithm to the real-time data and the determined routine information of the user, it may be determined that the time is 7:03 AM and the user has not taken his/her medications yet, and that the user usually takes his/her medications at 7 AM. According to the same example, the deviation level value may be relatively low, as the difference between the time at which the user usually takes his/her medications and the current time is only 3 minutes. However, as time passes, and the user still does not take the medications, the deviation level value may increase.

As another example, by applying the second algorithm to the real-time data and the determined routine information of the user, it may be determined that the user usually wakes up every morning at 6:30 AM, that the current time is 10:32 AM, and that the user is still asleep. According to the same example, the deviation level may be relatively high, as the difference between the time at which the user usually wakes up and the current time is more than four hours.

As another example, by applying the second algorithm to the real-time data and the determined routine information of the user, it may be determined that the user is usually very communicative and talks a lot with the digital assistant (e.g., the digital assistant 120). According to the same example, the real-time data may indicate that, for more than three hours from the moment the user woke up, the user did not talk with the digital assistant and did not respond to the digital assistant's attempts to interact. According to the same example, the deviation level value in this case may be relatively high. It should be noted that, in a case, according to the same example, where the user did not talk with the digital assistant for, for example, one hour, the deviation level value may be relatively low.

As another example, by applying the second algorithm to the real-time data and the determined routine information of the user, it may be determined that the user is usually very communicative and talks a lot with the digital assistant (e.g., the digital assistant 120). According to the same example, the real-time data may indicate that, for more than six hours from the moment the user woke up, the user did not talk with the digital assistant and did not respond to the digital assistant's attempts to interact. However, the collected real-time data may indicate that the user's children are in the house with the user, and that the user and his/her children are located in the kitchen and are cooking together, as they have been for hours. In such a case, the deviation level value may be relatively low. According to the same example, the deviation level value may be very high if the digital assistant 120 cannot identify the other people in the user's house, if the other people are acting in a suspicious way (such as, for example, shouting), if the other people are wearing suspicious clothing (such as, for example, masks), and the like, and if the user is still not interacting with the digital assistant 120.

As can be understood from the above example, the deviation level can be determined based on one or more data features (or parameters) of the routine information. Such data feature may be, for example and without limitation, the number of people in the room, the number of people in the vehicle, a room temperature, a noise level, an action performed by the user, the way an action is performed by the user, and the like.

At S370, the determined deviation level value is inputted into the decision-making model of the digital assistant. In an embodiment, S370 may further include determining whether the deviation level value is above a predetermined threshold value.

In an embodiment, the determined deviation level value is fed into a decision-making model of the digital assistant. Such decision-making model may include one or more artificial intelligence (AI) models that are utilized for determining plans (and actions that are related thereto) to be performed by the digital assistant. Thus, when the deviation level value is determined, at S360, the deviation level value is fed into the decision-making model, at S370, thereby providing for execution, at S380, by the decision-making model, of plans (e.g., actions) which suit the determined deviation level value.

For example, where the user usually wakes up every morning at 7 AM, and the time is now 11:36 AM and the user is still asleep, the deviation level value, indicating the deviation from the user's routine, is relatively high. According to the same example, and as further discussed hereinbelow, the determined deviation level value is fed into the decision-making model. Thus, the decision-making model may be configured to execute a plan that may include trying to wake the user by playing music, calling the user by his/her name, calling a relative, calling emergency services, or the like, as well as a combination thereof.

At S380, a plan is executed by the digital assistant (e.g., the digital assistant 120) using the decision-making model and based on the deviation level value. A plan may be used for, for example and without limitation, responding to an identified emergency, responding to a medical condition, responding to a suspicious, abnormal behavior of the user, or a behavior which occurs near the user, generating reminders for the user, generating alerts, generating suggestions, and the like. Execution of a plan may be performed using one or more resources (e.g., the resources 150), as further discussed hereinabove. In an embodiment, a plan may be executed upon determination that the determined deviation level value is above the abovementioned predetermined threshold value, as further discussed hereinabove.

Execution of a plan may include determination of one or more plans to execute. Determination of one or more plans to execute may include identification of a type of routine in which a deviation is identified, such as, as examples, and without limitation, sleeping routines, medication compliance routines, and the like, in addition to the deviation level value. Further, determination of one or more plans to execute may include identification of one or more optimal plans, wherein an optimal plan is a plan having the highest likelihood, of all possible plans, to ensure that the user's routine will be kept. That is, the optimal plan, when executed, is determined or otherwise selected to immediately cause adjustment of a user's current a behavior to his/her routine behavior. The optimal plan may be selected based on the determined deviation level value. In an embodiment, a set of plans are determined, and their order or execution is predetermined as well.

As a first example, a high deviation level value, indicated with respect to a medication compliance routine, may cause, at S380, execution of a medication-reminder plan configured to interrupt a user mid-conversation or to wake a user up from sleep. As a second example, a low deviation level value, indicated with respect to a medication compliance routine, may cause, at S380, execution of a medication-reminder plan configured to provide non-intrusive reminders, such as by displaying a reminder after the user interacts with a digital assistant.

For example, by applying the second algorithm to the real-time data and the determined routine information of the user, it may be determined that the time is 7:00 PM, and that the user has not taken his/her medications yet, although the user usually takes his/her medications at 6:30 PM. According to the same example, the decision-making model of the digital assistant 120 may execute a plan that reminds the user to take his/her medications. According to the same example, if the real-time data indicates that the user has not taken his/her medications and that several people are identified in the user's house, the decision-making model may be updated with this information and, therefore, the decision-making model may execute a plan which would track the number of people in the user's house and remind the user only when the user is alone again. According to the same example, when it is determined that it is desirable to remind the user to take his/her medications and the user is not alone, the chosen plan may include, for example and without limitation, presenting a clue which would remind the user about the need to take his/her medications without embarrassing the user, sending a text message to the user's smartphone, or the like.

Execution of a plan may be performed using one or more resources (e.g., the resources 150). For example, speakers may be used for calling the user by his/her name, an illumination system that is controlled by the digital assistant may be used for emitting light and drawing the user's attention, a display may be used for displaying visual content, or the like. According to another example, the executed plan may include calling emergency services, providing information about the condition of the user to emergency services, sending an image of the user, sending a video of the user, or the like, to the emergency services, sending the same to a predetermined contact, and the like.

In an embodiment, executing a plan by the digital assistant may occur upon determination that the deviation level value from the determined routine information of the user is above a predetermined execution threshold value. The predetermined execution threshold value may be, for example, a known score (e.g., 6 out of 10), providing for distinguishing between cases in which the deviation from the user normal behavior, parameters, patterns, or the like (e.g., the user's routine) is small and cases in which the deviation is large and requires intervention of the digital assistant. The predetermined execution threshold value may be automatically determined and updated through time by the digital assistant based on information that is collected with respect to the user.

For example, the first dataset may indicate that, although the user is ninety years old, the user is usually a lucid person. According to the same example, in the case where the real-time data indicates that the user is trying to drink his/her morning coffee from an empty mug, the deviation level value may cross the predetermined threshold value and, therefore, a plan which includes sending an alert to the user's children, the user's doctor, or both, may be executed. As another example, when the user forgets to take medications on time, but the delay is only thirty minutes, the deviation level value may be below the predetermined execution threshold value.

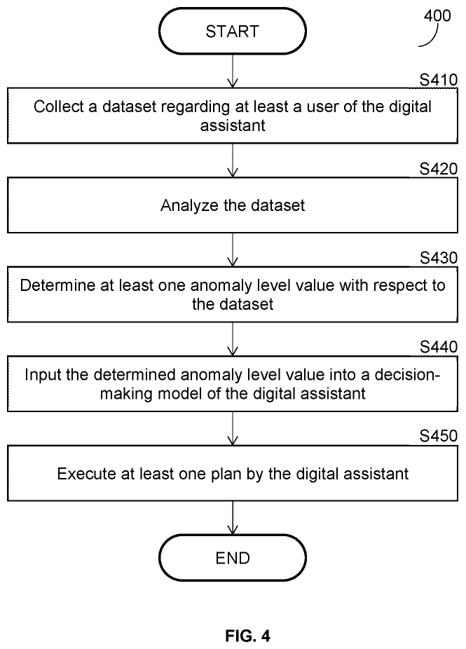

FIG. 4 is an example flowchart 400 illustrating a method for executing a plan by a digital assistant based on a detected anomaly level value that is associated with a user of the digital assistant, according to an embodiment.

The method described herein may be executed by a digital assistant by means of the controller (e.g., controller 130, that is further described hereinabove with respect to FIG. 2. Alternatively or collectively, the method may be performed by the I/O device 170.

At S410, a dataset regarding at least the user of the digital assistant (e.g., the digital assistant 120) is collected. The dataset may be collected using at least a first sensor (e.g., one of the sensors 140) that is communicatively connected to the digital assistant (the digital assistant 120). The dataset may include features that are associated with the user and features that are related to an environment in a predetermined proximity to the user. The predetermined proximity may be, for example, ten meters from the user, seven meters from the digital assistant, and the like. Features that are associated with the user may include, for example and without limitation, the user's voice, the user's tone, face shape, facial expressions, body temperature, and the like. Features that are associated with the environment near the user may include, for example and without limitation, the temperature outside the user's vehicle, the temperature inside the user's house, the number, and identities, of people in the user's house, the time, and the like. In an embodiment, the dataset includes real-time data and may also include historical data, users' population data, such as data describing one or more properties of a person or group of people, including, without limitation, age, gender, country, and the like, as well as other, like data, and any combination thereof. In addition, data collected at S410 may include data collected from one or more network sources including, without limitation, databases, website servers, social media accounts, and the like, as well as any combination thereof.

Further, data collected at S410 may include real-time data. The collected real-time data may include data relevant to one or more users, the environment surrounding the one or more users, other, like, real-time data, and any combination thereof.

At S420, the dataset is analyzed. The analysis of the dataset may include applying at least a first algorithm, such as an anomaly detection algorithm, to the collected dataset. The first algorithm may be a machine learning (ML) algorithm, including a supervised ML algorithm or an unsupervised ML algorithm. The collected dataset may be fed into the first algorithm, thereby allowing the first algorithm to generate an output which facilitates determination of an anomaly level value of at least one feature of the collected dataset. The analysis of the dataset at S420 may include the generation of one or more analysis outputs, such outputs including, without limitation, features extracted from the dataset, and the like, as well as any combination thereof. As described hereinabove, extracted features may be subsequently applicable to the identification of user states. Further, analysis at S420 may include one or more aspects, elements, or the like, of analysis at S320 of FIG. 3, above.

As an example, at least a portion of the dataset collected at S410 (e.g., real-time data that was collected by one or more sensors) may indicate that the user is lying on the kitchen floor. According to the same example, after the dataset is fed into the anomaly detection algorithm, the output of the anomaly detection algorithm may indicate that it is abnormal that the user is lying on the kitchen floor. As an example, the dataset may indicate that the user's eyes are closed for more than three seconds while the vehicle in which the user is sitting is traveling at 80 miles per hour, and that the auto-pilot system of the vehicle is off. According to the same example, after the dataset is fed into the anomaly detection algorithm, and all of the aforementioned features are taken into account, the anomaly detection algorithm may determine that the described situation is abnormal.

At S430, at least one anomaly level value is determined with respect to the analysis outputs generated at S420. In an embodiment, the at least one anomaly level value is determined with respect to the analysis outputs generated at S420 and historical routine data which is user-independent, such as global average routine information. The anomaly level value may be, at S420, determined by application of one or more ML models, including both supervised ML models and unsupervised ML models, to the analysis output generated at S420, where such ML models may be configured to identify anomaly levels. In an embodiment, the ML model may be an unsupervised model configured to identify anomalies based on feature extraction. Further, an anomaly level value may be determined with respect to the collected and analyzed dataset by application of one or more anomaly-scoring algorithms or models, as are known in the art. The anomaly level value provides for determination of whether an anomaly has been detected, as well as the intensity of the detected anomaly.

It should be noted that the anomaly level value may be determined with respect to a collection of features of the dataset. That is, it may be normal that a user is lying on the living room floor when a yoga mat is located beneath him/her and the user is moving. However, when the features extracted from the dataset indicate that the user is lying on the living room floor, that no mat is identified, and that the user has not moving in more than one minute, a relatively high anomaly level value may be determined based on the collection of features.

At S440, the determined anomaly level value is inputted into a decision-making model of the digital assistant (e.g., the digital assistant 120). Inputting the determined anomaly level value, at S440, may include one or more aspects, elements, or the like, which may be similar or identical to those described with respect to the inputting step, S370, of FIG. 3, above. A decision-making model of the digital assistant 120 may include one or more artificial intelligence (AI) algorithms that are utilized for determining plans (and actions that are related thereto) to be performed by the digital assistant 120. Thus, when the anomaly level value is determined, the anomaly level value is fed into the decision-making model, thereby allowing the decision-making model to execute plans (e.g., actions) which suit the determined anomaly level value.

For example, where the dataset (e.g., the real-time data) indicates that the user is holding his/her chest, and where user also appears to have breathing problems, the anomaly level value may be relatively high. As another non-limiting example, where the dataset (e.g., the real-time data) indicates that the user is awake at 3 AM, the anomaly level may be relatively high. According to the same example, the digital assistant may suggest that the user turn off the air conditioner upon determination that the room is too cold.

At S450, a plan is executed by the digital assistant. The plan may be executed using the decision-making model and based on the collected dataset and the determined anomaly level value. Plan execution, at S450, may include one or more aspects, elements, or the like, which may be similar or identical to those described with respect to plan execution at S380 of FIG. 3, above. As discussed above, plan may be used for, for example and without limitation, responding to an identified emergency, responding to a medical condition, responding to abnormal behavior of the user, or to abnormal behavior that occurs near the user, generating reminders for the user, generating alerts, generating suggestions, and the like.

For example, by applying the first algorithm (e.g., the anomaly detection algorithm) to the dataset it may be determined that the user is sitting in a vehicle, that the vehicle just crashed, and that the user is injured. According to the same example, the anomaly level value is determined as high and the decision-making model that receives the input (i.e., the determined anomaly level value) may execute a plan which suits the situation. According to the same example, the executed plan may include calling emergency services, providing information about the medical condition of the user to emergency services, sending an image of the user, a video of the user, or the like, to the emergency services, and the like. According to another example, when the dataset indicates that the user is alone at home for more than thirty-six hours, the anomaly level may be relatively high. According to the same example, the digital assistant may suggest that the user go out for a walk upon determination that the weather outside is pleasant.

As another example, a first portion of the dataset (e.g., historical data) may indicate that the user usually does not exercise. However, a second portion of the dataset (e.g., real-time data) may indicate that the user has just returned from a yoga class. Therefore, a relatively high anomaly level value may be determined with respect to the collected dataset (where the dataset includes both real-time and historical data). Then, the determined anomaly level value may be inputted into the decision-making model of the digital assistant (e.g., the digital assistant 120) and a corresponding plan may be executed. According to the abovementioned example, the plan may include encouraging the user by emitting a sentence (e.g., by the digital assistant 120) such as: “well done, it's great to see you are starting to adapt to a new way of life.”

In an embodiment, execution of a plan may be performed using one or more resources (e.g., the resources 150). For example, speakers may be used for calling the user, an illumination system, which is controlled by the digital assistant 120, may be used for emitting light and drawing the user's attention, a display may be used for displaying visual content, and the like.

In an embodiment, executing a plan by the digital assistant 120 may occur upon determination that the anomaly level value is above a predetermined execution threshold value. The predetermined execution threshold value may be, for example, a known score (e.g., 6 out of 10), providing for distinguishing between cases in which the determined anomaly level value is low and cases in which the anomaly level value is high and requires intervention of the digital assistant 120. The predetermined execution threshold value may be automatically determined and updated through time by the digital assistant 120. For example, the dataset may indicate that the user is sitting in a vehicle and that the user's respiratory rate is thirty-two breaths per minute (which is an abnormal rate for an adult). According to the same example, the anomaly level value may be 8 out of 10, while the predetermined execution threshold value may be 6. Therefore, a plan may be executed by the decision-making model of the digital assistant 120.

As another example, the real-time data may indicate that the user's respiratory rate is thirty-two breaths per minute (which is an abnormal rate for an adult). However, the real-time data may further indicate that the user has just finished working out and that, therefore, the anomaly level value may be relatively low and a plan may not be executed as the predetermined execution threshold may not be crossed.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C, 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for operating a digital assistant based on deviation from routine behavior of a user using the digital assistant, comprising:
analyzing a first collected dataset to determine at least routine information regarding the user;
analyzing a second dataset and the determined routine information regarding the user to determine a deviation level value, the deviation level value describing the deviation of a current behavior from routine behavior of the user, and wherein the second dataset includes real-time data regarding the user;
determining a plan for the digital assistant, wherein the plan includes at least one action to be performed by the digital assistant; and
operating the digital assistant based on the determined plan, thereby causing the digital assistant to adjust the behavior of the user.

2. The method of claim 1, wherein the first dataset includes at least one of: user data, historical data, environmental data, and sensor data.

3. The method of claim 2, wherein the first dataset is collected via at least one of:
a sensor, and a resource external to the digital assistant.

4. The method of claim 1, wherein determining the deviation level value further comprises:
comparing at least one parameter of the second dataset with at least one baseline parameter.

5. The method of claim 1, wherein determining the deviation level value further comprises:
determining at least one user state parameter; and
comparing the at least one user state parameter with at least one routine information parameter.

6. The method of claim 1, wherein determining the plan for the digital assistant further comprises:
feeding the determined deviation level value into a decision-making model (DMM) of the digital assistant; and
identifying an optimal plan from at least one plan provided by the DMM.

7. The method of claim 1, wherein the optimal plan is the plan having the highest likelihood, of all possible plans, to immediately cause adjustment of a user's current behavior to the user's routine behavior.

8. The method of claim 1, wherein the digital assistant is a social robot configured to interact with the user.

9. A non-transitory computer readable medium having stored thereon instructions for causing a processing circuitry to execute a process, the process comprising:
analyzing a first collected dataset to determine at least routine information regarding the user;
analyzing a second dataset and the determined routine information regarding the user to determine a deviation level value, the deviation level value describing the deviation of a current behavior from routine behavior of the user, and wherein the second dataset includes real-time data regarding the user;
determining a plan for the digital assistant, wherein the plan includes at least one action to be performed by the digital assistant; and
operating the digital assistant based on the determined plan, thereby causing the digital assistant to adjust the behavior of the user.

10. A system for operating a digital assistant based on deviation from routine behavior of a user using the digital assistant, comprising:
a processing circuitry; and
a memory, the memory containing instructions that, when executed by the processing circuitry, configure the system to:
analyze a first collected dataset to determine at least routine information regarding the user;
analyze a second dataset and the determined routine information regarding the user to determine a deviation level value, the deviation level value describing the deviation of a current behavior from routine behavior of the user, and wherein the second dataset includes real-time data regarding the user;
determine a plan for the digital assistant, wherein the plan includes at least one action to be performed by the digital assistant; and
operate the digital assistant based on the determined plan, thereby causing the digital assistant to adjust the behavior of the user.

11. The system of claim 10, wherein the first dataset includes at least one of: user data, historical data, environmental data, and sensor data.

12. The system of claim 11, wherein the first dataset is collected via at least one of:
a sensor, and a resource external to the digital assistant.

13. The system of claim 10, wherein the system is further configured to:
compare at least one parameter of the second dataset with at least one baseline parameter.

14. The system of claim 10, wherein the system is further configured to:
determine at least one user state parameter; and
compare the at least one user state parameter with at least one routine information parameter.

15. The system of claim 10, wherein the system is further configured to:
feed the determined deviation level value into a decision-making model (DMM) of the digital assistant; and
identify an optimal plan from at least one plan provided by the DMM.

16. The system of claim 10, wherein the optimal plan is the plan having the highest likelihood, of all possible plans, to immediately cause adjustment of a user's current behavior to the user's routine behavior.

17. The system of claim 10, wherein the digital assistant is a social robot configured to interact with the user.
